(19) United States
(12) Patent Application Publication
(10) Pub. No.: US 2014/0027332 A1
(43) Pub. Date: Jan. 30, 2014

(54) HOLDING STRUCTURE FOR SIMULTANEOUSLY HOLDING A PLURALITY OF CONTAINERS FOR MEDICAL, PHARMACEUTICAL OR COSMETIC APPLICATIONS AND TRANSPORT OR PACKAGING CONTAINER WITH HOLDING STRUCTURE

(71) Applicant: Schott AG, (US)

(72) Inventors: Edgar PAWLOWSKI, Stadecken-Elsheim (DE); Kai WISSNER, Mainz (DE); Joel COULON, St. Gallen (CH); Ralph LOVIS, Winterthur Schweiz (DE); Carmen HEITER, St. Gallen (CH)

(21) Appl. No.: 13/886,717

(22) Filed: May 3, 2013

Related U.S. Application Data
(60) Provisional application No. 61/642,154, filed on May 3, 2012.

(30) Foreign Application Priority Data
May 3, 2012 (DE) 10 2012 103 898.8

(51) Int. Cl. A61J 1/14

(52) U.S. Cl. CPC A61J 1/14
USPC 206/438; 248/346.03; 248/346.04

(57) ABSTRACT

A supporting structure is provided that concurrently supports a plurality of containers for substances for medical, pharmaceutical or cosmetic applications. The supporting structure includes a planar supporting base having a plurality of openings, which are disposed in a regular array configuration, and an associated holding device that supports the plurality of containers in a positive-fit manner at the supporting base. The holding device protrudes from a bottom side of the supporting base and is configured to support the plurality of containers in the positive-lit manner at their upper rim. Additionally, receptacles are provided on an upper side of the supporting base opposite to the bottom side for accommodating containers at the upper side of the supporting base.

The present application claims priority from German Patent Application No. 10 2012 103 898.8 “Supporting structure for concurrently supporting a plurality of medical or pharmaceutical containers and transport or packaging container with the same”, filed on 3 May 2012, and from U.S. Patent Application Ser. No. 61/642,154 “Support structure for simultaneously holding a plurality of medical or pharmaceutical containers and transport containers or packaging container comprising such a support structure”, filed on 3 May 2012, the entire contents of which are hereby incorporated by way of reference.

### FIELD OF THE INVENTION

The present invention relates in general to the concurrent holding or supporting of a plurality of containers for the storage of substances for medical, pharmaceutical or cosmetic applications, in particular of flasks (vials), and more particularly to concurrently supporting a plurality of containers in a supporting structure in such a manner that they may be processed further in filling or processing stations while being held therein, in particular in a sterile tunnel, a filling station for liquid for medical or pharmaceutical substances or in a freeze-dryer therefor.

### BACKGROUND OF THE INVENTION

As containers for keeping or storing medical, pharmaceutical or cosmetic preparations with administration in liquid form, in particular in pre-dosed amounts, medication containers are widely used, for example vials, ampoules or carpoules. These generally have a cylindrical shape, may be made of plastics or glass, and are available in large quantities at low costs. For an economical as possible filling of the containers under sterile conditions concepts are used to an increasing extent according to which the containers are packaged in a sterile manner in transport and packaging containers directly by the manufacturer of the containers, which are then unpackaged and then further processed at a pharmaceutical company under sterile conditions, especially in a so-called sterile tunnel.

For this purpose, various transport and packaging containers (so-called tubs) are known from the prior art in which a plurality of medication containers are arranged concurrently in an array, for example in a matrix configuration along rows and columns extending perpendicularly thereto. This has advantages in the automated further processing of the containers, because the containers can be transferred to processing stations at controlled positions and in a predetermined arrangement, for example to processing machines, robots or the like. To this end supporting structures (so-called nests) can be used in which a plurality of containers can be held concurrently in a predetermined array. For a transfer to a processing station the transport and packaging container just needs to be positioned properly and opened. The downstream processing station will then know at what position and arrangement the containers to be processed further are arranged.

Such a transport and packaging container and a corresponding packaging concept are for example disclosed in U.S. Pat. No. 8,118,167 B2. The further processing of the containers is performed, however, always in such a way that the holding structure will be removed from the transport and packaging container, that the containers are removed from the supporting structure and isolated and are transferred to the processing stations individually on a conveying device, in particular on a conveyor, for further processing. This limits the speed of further processing that can be achieved. Particularly in the case of the isolation of containers by means of cell wheels or the like, it always happens that individual containers abut uncontrolled, leading to an undesired abrasion and subsequently to a contamination of the interior of the container or of the processing station as well as to an impairment of the outer appearance of the containers, which is undesirable.

U.S. Pat. No. 8,100,263 B2 discloses a portable transport and packaging container that can be packaged in a sterile manner, in which a plate-shaped supporting structure can be used in which a plurality of medication containers are supported in a regular array. In the beginning, the individual medication containers are placed loosely in receptacles formed in the supporting structure. Subsequently, the supporting structure is inserted in the transport and packaging container and this is surrounded with a gas-impermeable plastic tube. Upon subsequent evacuation of the so-formed packaging unit, the plastic tube is pressed into the spaces between the medication containers due to the under pressure prevailing in the tube, which thus, on the one hand, leads to a stabilization of the positions of the medication containers in the supporting structure and, on the other hand, prevents further uncontrolled collisions of adjacent medication containers. Upon evacuation and the subsequent opening of the plastic tube, however, the medication containers may slip sideways, which increases the automation efforts required for processing further the medication containers. In addition, the medication containers may still collide uncontrolled after opening of the plastic tube, resulting in the aforementioned disadvantages. The medication containers cannot be processed further in the transport or packaging container or in the supporting structure, but must be isolated in the conventional manner and transferred to downstream processing stations first.

Further comparable transport and packaging containers and supporting structures are disclosed in WO 2011/135085 A1, US 2011/0277419 A1, WO 2012/025549 A1, WO 2011/015896 A1, WO 2012/007056 A1 and WO 2009/015862 A1. However, for further processing the medication containers must always be isolated or separated. A batch-wise further processing of the medication containers while they are accommodated in a plate-like supporting structure, as mentioned above, is not possible.

In any case, a direct contact of the bottoms of the medication container, in particular of the bottoms of vials, is not possible in the conventional supporting structures. However, this complicates the further processing of the medication containers, in particular when their content is to be subjected to a freeze-drying process (also referred to as lyophilization or sublimation drying). Furthermore, a further processing of the medication containers directly in the supporting structures is not possible, because these are either held rigidly or are not accessible to a sufficient extent for a further processing, so that the medication containers conventionally always need to be removed from the supporting structures.

### SUMMARY OF THE INVENTION

It is an object of the present invention to further enhance a supporting structure for concurrently holding a plurality of containers for medical, pharmaceutical or cosmetic applications, in particular of vials made of glass, such that a sterile packaging, de-packaging and further processing of the containers is possible in an easy and cost-efficient manner. According to a preferred further aspect of the present invention such a supporting structure shall be configured particularly for a further processing of the containers while these are supported in the supporting structure. According to a further aspect of the present invention, a corresponding transport and packaging container is to be provided comprising at least one such supporting structure.

According to the invention the containers are supported in the supporting structure in a positive-fit manner. For the positive-fit supporting of cylindrical containers various holding means are available. The relative displacement between the container and supporting structure is prevented as long as one coupling partner is in the way of the other coupling partner, i.e. locks it.

According to a first aspect, there is provided a supporting structure for concurrently holding a plurality of cylindrical containers for substances for medical, pharmaceutical or cosmetic applications, comprising a planar rectangular supporting base having a plurality of openings, which are disposed in a regular array configuration, and holding means associated with said openings for supporting said plurality of containers at said supporting base in a positive-fit manner, characterized in that said holding means protrude from a bottom side of said supporting base and are configured for supporting said containers at their upper rim in a positive-fit manner, and that receptacles are provided on an upper side of said supporting base opposite to said bottom side, which are configured for accommodating containers at the upper side of said supporting base.

By means of the holding means the containers can be supported reliably on the bottom side of the supporting base. At the same time, by means of the receptacles further containers can be supported at the upper side of the supporting base at a high packing density. Thus, according to the invention a plurality of such supporting structures (so-called nests) can be stored stacked one above the other together with the containers supported, which results in significant advantages during the processing and handling of the containers, because processing stations having a smaller base area may be used.

The holding means may be configured such that also containers that are already sealed can be supported on the supporting base, for example, sealed by a metal lid that is crimped onto the upper end of the container or vial.

Generally, the containers can be accommodated in the receptacles at a certain distance to the upper side of the supporting base. According to a further embodiment, the receptacles can also be configured such that bottoms of the containers are supported directly on the upper side of the supporting base.

According to a further embodiment, the receptacles can be formed by circumferential side walls, wherein an inner diameter of the receptacles thus formed is preferably matched to the outer diameter of the containers to be accommodated therein. For example, the bottom ends of the containers can be clamped in the receptacles. For this purpose, the receptacles may be formed in particular of an elastic plastic material.

According to a further embodiment the holding means are formed as resilient latching hooks, which project from the bottom side of the supporting base and which are disposed distributed around the openings of the supporting base. Preferably, the latching hooks are configured to engage behind the upper rim of the containers in a positive-fit manner in order to fix the containers.

In order to support the containers on the supporting base, the latching hooks are elastically spread apart during insertion of the containers. For this purpose, the latching hooks may have a bottom insertion bevel, which comes into contact with the upper ends of the containers during insertion of the containers from the bottom side of the supporting base and along which the upper ends of the containers then slide to spread apart the latching hooks.

According to still a further embodiment, the latching hooks further have a bevel or a slanted support or abutment surface, which faces the respective opening of the supporting base and on which the upper rim of the supported container rests. If the container shall be removed again from the supporting base, the upper rims of the containers slide downward along the downwardly inclined support or abutment surface to elastically spread apart the latching hooks again. Thus the removal of the containers from the supporting base is relieved.

According to a preferred embodiment the latching hooks are formed integrally with the supporting base. Suitably, also the receptacles on the upper side of the supporting base are formed integrally therewith.

According to a first aspect, there is provided a supporting structure for concurrently holding a plurality of containers for substances for medical, pharmaceutical or cosmetic applications, comprising a planar rectangular supporting base having a plurality of openings or receptacles, which are disposed in a regular array configuration, and associated holding means for supporting the plurality of containers at said supporting base in a positive-fit manner. According to the invention, the supporting structure is characterized in that the holding means are formed as flaps that are arranged distributed around the openings or receptacles of the supporting base, wherein the flaps associated with a respective opening or receptacle are pivoted away in a first position in which the opening or receptacle is completely released and are flapped back in a second position towards the opening or receptacle in order to jointly support an upper rim of the container that is accommodated in the respective opening or receptacle.

Because the flaps release the associated opening or receptacle completely in their first positions, the containers can be inserted into the openings or receptacles of the supporting base and removed again easily and reliably.

Conveniently, the positive-fit coupling is implemented either below the expanded upper rim of the containers, i.e. in the region of the constricted neck or neck portion and directly below the upper rim, or at the bottom end of the containers, e.g. at a bottom of the containers. Conveniently, the expanded upper rim or the bottom end or bottom of the containers is directly supported on the positive-fit members of the holding structure. Alternatively, the upper rim or the bottom end or bottom of the containers may be embraced or engaged behind in a positive-fit manner. According to the invention a bottom-side supporting of the containers is generally not required so that an access to the bottom sides (bottoms) of the containers supported in the supporting structure is in general possible. According to the invention this makes it possible that the containers can be processed further, while being accommodated in the supporting structure. In other words, the containers can be processed further batch-wise while being in the supporting structures, but remain held by the supporting structure reliably and free of collisions during the further processing, which allows significant speed advantages and benefits in the automation of processing stations and so overall even more economical and cost-effective processes. Particularly, the containers (vials) can be raised in axial direction or rotated in the supporting structure. According to further embodiments the containers can also be lyophilized while being in the supporting structure, because a direct contact with a cooling finger of the freeze-dryer is possible. Bottom ends or upper ends of the containers can be fixed in a simple manner at a given altitude, so that all bottoms can be arranged in a plane commonly spanned, which allows a direct contact to planar processing stations, in particular to a cooling finger or a cooling tray of a freeze-dryer. Furthermore, a direct glass-to-glass contact between adjacent containers is prevented reliably by means of separating webs or the like, effectively preventing abrasion and contamination within the processing station and thus enabling significantly longer maturities and maintenance intervals of the equipment. Furthermore, scratches or the generation of particles on or in the containers can be effectively prevented. The supporting structure according to the invention advantageously permits removal of the containers upwards or downwards. Because the location of the positive-fit coupling between the container and the supporting structure can be easily varied, the supporting structure of the present invention can be used very flexibly also for containers having different outer dimensions. In particular, the containers can be displaced easily in the axial direction while being in the supporting structure so that containers of different heights can be supported in the same supporting structure. The axial displaceability of the containers in the supporting structure also allows for easy compensation of tolerances or a further-processing of the containers, while they are held in the supporting structure. They may, for example, be displaced from a first position axially to a second position while being accommodated in the supporting structure and they can be further processed in the second position, for example, for closing their openings by means of applying an outer cap (for example, a staple or crimp), often from aluminum sheet, on the plug.

According to further embodiments, the containers are processed further while they are accommodated in the supporting structure and in the transport and packaging container. However, if despite all precautions a container rupture should occur, this does not result in a contamination of the system, because the rubble but also potential agents or solutions remain in the transport and packaging container.

The supporting structure comprises holding means, as described more fully below, which are arranged in a regular array configuration, in particular in a matrix array along rows and columns extending perpendicular thereto, or in a regular array of rows of openings or receptacles which are displaced relative to each other. This arrangement of the holding means can be optimized with respect to their position to achieve a packing density of the containers as high as possible.

According to a further embodiment, at least a major part of the bottoms or bottom ends of the containers is freely accessible from the bottom side of the supporting structure. Preferably, these vial bottoms are not covered by any supporting structures or the like. According to further embodiments, however, a supporting web or the like may be provided at the bottom ends of the openings or receptacles of the supporting structure for supporting the bottoms or bottom ends of the containers. Thus, an adjusting device, such as an adjustment finger, can act on the bottoms or bottom ends of the containers from the bottom side of the supporting structure in order to displace them in axial direction or rotate them while being supported in the supporting structure. For example, the containers can be suitably raised and can be processed further in the raised position and while they are held in the supporting structure, for example, to be provided with an outer closure (crimped cap or lid). For the adjustment of the position of the containers in the supporting structure, in accordance with further embodiments, the opening width of the holding means can be adjusted, in particular the opening width of openings or receptacles, as described hereinafter, so that the positive-fit coupling is released or substantially reduced at a greater opening width and persists at a smaller opening width for reliably supporting the containers.

According to a further aspect of the present invention there is provided a supporting structure for concurrently supporting a plurality of cylindrical containers for substances for medical, pharmaceutical or cosmetic applications, comprising a planar rectangular supporting base having a plurality of openings or receptacles, which are disposed in a regular array configuration, and having associated holding means for supporting said plurality of containers at said supporting base in a positive-fit manner. According to the invention the holding means are formed as flaps, which are arranged distributed around the openings or receptacles of the supporting base, wherein the flaps associated with a respective opening or receptacle are pivoted away in a first position, in which the opening or receptacle is completely released, and are flapped back in a second position towards the opening or receptacle in order to jointly support an upper rim of the container accommodated in the respective opening or receptacle.

According to a further embodiment, the flaps are formed integrally with the supporting base.

According to a further embodiment, the flaps are connected with the supporting base via a connecting portion, wherein a material thickness of the connecting portion is smaller than that of the supporting base and/or of the flaps so that the flaps are pivotally and resiliently mounted on the supporting base.

According to a further embodiment, the flaps are positively connected to the supporting base.

According to a further embodiment, the flaps comprise pins projecting sideward, wherein the pins are clipped into corresponding receptacles which are formed on the supporting base.

According to a further embodiment, the front ends of the flaps (145) have a recess shaped as a segment of a circle, whose radius of curvature is matched to the outer radius of the containers to be supported.

According to a further embodiment, the flaps are rectangular.

According to a further embodiment, the flaps are provided at the upper rim of the associated receptacles, wherein the receptacles have a rectangular or square-shaped cross-section, the opening width of which is matched to the outer diameter of the containers to be supported.

A further aspect of the present invention also relates to a transport and packaging container having at least one supporting structure as set forth above and hereinafter disclosed in more detail.

A further aspect of the present invention also relates to a transport and packaging container having counterfeit protection measures, particularly for an identification and/or tracking, as described hereinafter.

### OVERVIEW ON DRAWINGS

The invention will now be described by way of example and with reference to the accompanying drawings, from which further features, advantages and problems to be solved will become apparent. In the drawings:

FIGS. 1a-1c show a transport and packaging container according to a first embodiment of the present invention;

FIG. 1d shows a variant of the supporting structure according to FIG. 1a, which serves for further enhancing the packing density of the containers;

FIGS. 1e-1h show further variants for the positive-fit fixation of the containers in a supporting structure according to FIG. 1a;

FIGS. 2a-2c show a transport and packaging container according to a further embodiment of the present invention;

FIGS. 3a-3b show a supporting structure according to a further embodiment of the present invention;

FIGS. 4a-4c show a supporting structure according to a further embodiment of the present invention;

FIG. 5a-5d show a supporting structure according to a further embodiment of the present invention;

FIG. 6 show a transport and packaging container according to a further embodiment of the present invention comprising a protection or packaging foil; and

FIGS. 7a-7b show measures for identification and/or tracking in a transport and packaging container according to the present invention.

In the drawings, identical reference numerals designate identical or substantially equivalent elements or groups of elements.

### DETAILED DESCRIPTION OF PREFERRED EMBODIMENTS

A supporting structure (in the prior art often referred to also as “nest”) as well as a transport and packaging container (in the prior art often referred to also as “tub”) that receives such a supporting structure used in the present invention, as described below, are used for concurrently supporting a plurality of containers for storage of substances for cosmetic, medical or pharmaceutical applications, in a regular arrangement, in particular in a matrix array at regular distances of the containers to each other, along two different directions in space, preferably along two mutually orthogonal spatial directions or regular rows, which are displaced relative to each other.

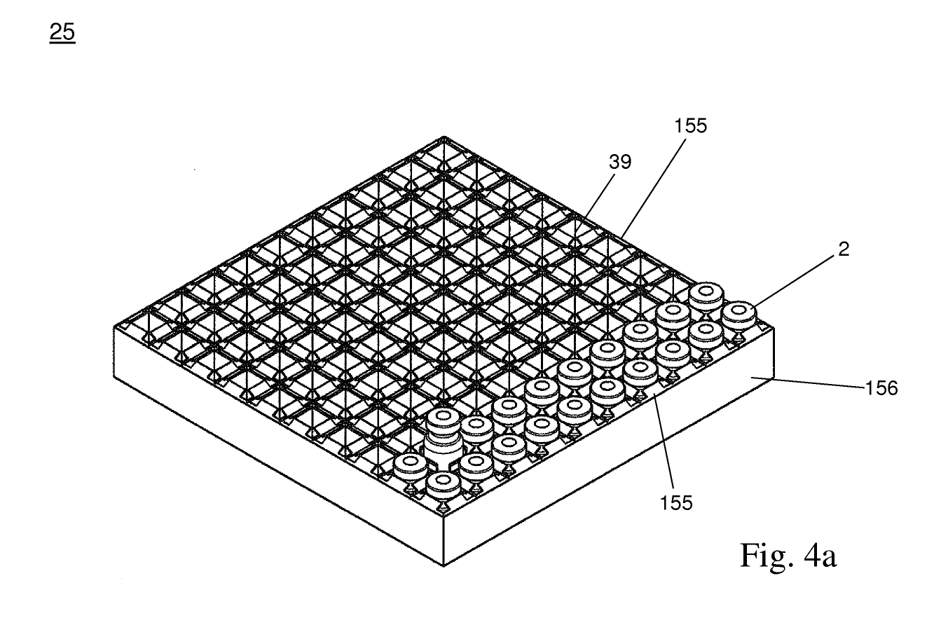

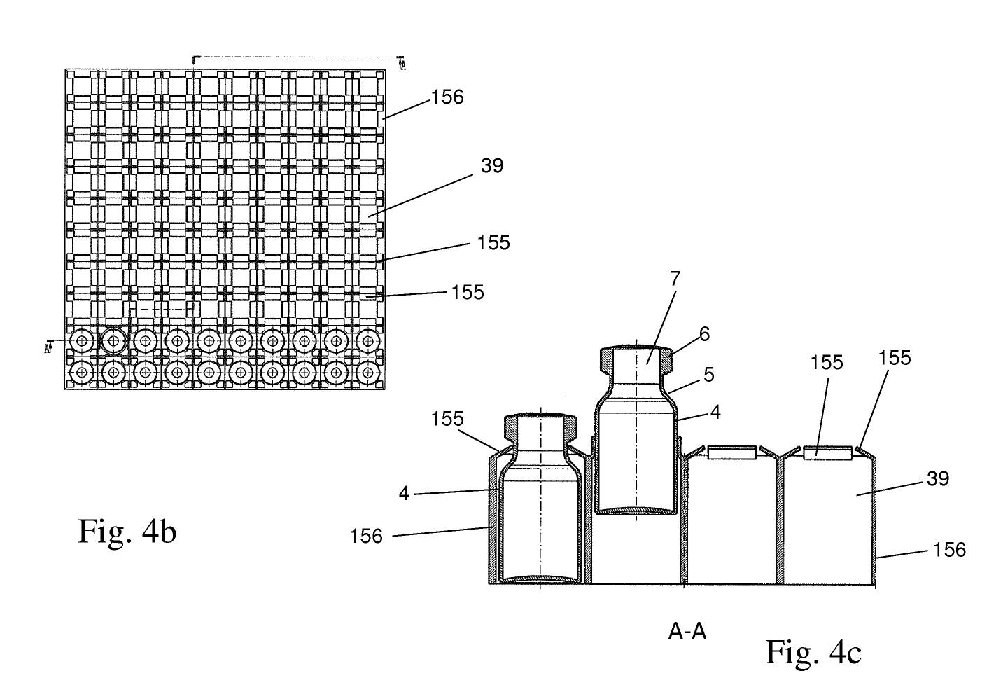

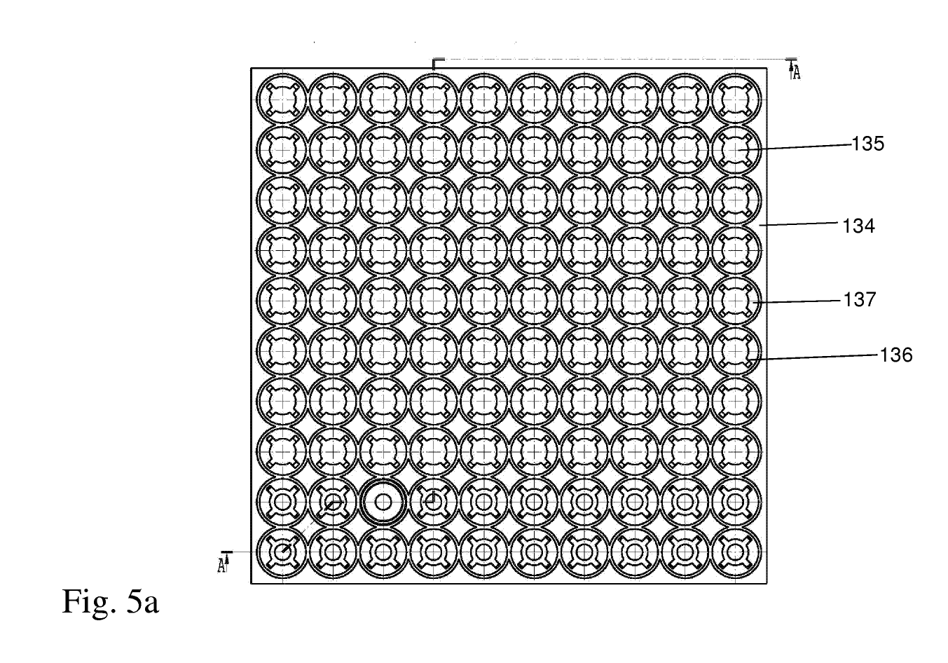

An example of such medication containers in the form of vials (English: vial) is shown schematically in FIG. 4c in a longitudinal section and have a cylindrical basic shape, having a cylindrical side wall having—within tolerances—a constant inner and outer diameter, which protrude vertically from a flat vial bottom 3 and merge into a narrowed neck portion 5 of a relatively small axial length close to the upper open end of the vial and then merges into an enlarged upper rim 6, which has a larger outer diameter than the associated neck portion 5 and is configured to be coupled to a closure element. The neck portion 5 can be formed with smooth walls and without an external thread or may be provided with an external thread for screwing on a closure member. For example, a plug (not shown) may be inserted in the inner bore of the neck portion 5 or of the upper rim 6, whose upper end is gas-tight and protected against the ingress of contaminants and is attached to the upper rim 6 of the vial, e.g. by crimping or beading a metal protective film not shown. Such vials are radial symmetric and are made of a transparent or colored glass or by blow molding or plastic injection molding techniques of a suitable plastic material, and can in principle be internally coated so that the material of the vial emits minimal impurities to the substance to be stored.

A further example of medication containers according to the present application are ampoules, carpoules, syringes or injection containers. Ampoules or carpoules are containers for medication agents for usually parenteral administration (injection), for cosmetics and other agents and are usually cylindrical in shape with an extended tip (spear or head) and a flat bottom or also with two extended tips at both ends. These may be formed in particular as snap-off ampoules with an annular predetermined breaking point around the ampoule neck or as an OPC cartridge (OnePoint-cut ampoule) having a breaking ring inscribed into the glass. Syringes or injection containers, also known as injection flask, vial or reusable ampoule, are cylindrical containers of glass or plastic shaped similar to a bottle, usually having a relatively small nominal volume (e.g. 1 ml, 10 ml). They are sealed with a rubber plug with septum (puncture rubber). For protecting the septum and fixing the rubber plug an outer closure (beaded cap or cramp), often made from an aluminum sheet, is necessary. In a carpoule the liquid is stored in a cylinder, which is closed at one end by means of a thick rubber or plastic plug. This acts as a piston when the content is pressed out using a carpoule syringe. At the other end the cylinder is closed only by means of a thin diaphragm, which is pierced from the rear end of the carpoule syringe (a cannula sharpened on both sides) in the application. Cylindrical ampoules are often used in dentistry for local anesthesia. Special cylindrical ampoules with a specially shaped front part (e.g. thread) are used for insulin therapy in insulin pens.

In the sense of the present invention, such containers are used for storage of substances or agents for cosmetic, medical or pharmaceutical applications, which are to be stored in one or several components in solid or liquid form in the container. Especially in the case of glass containers storage periods can amount many years, notably depending on the hydrolytic resistance of the glass type used. While, in the following, cylindrical containers are disclosed, it should be noted that the containers, in the sense of the present invention, may also have a different profile, for example a square, rectangular or polygonal profile.

Inevitably such containers have tolerances due to the production which can be of the order of one or several tenths of a millimeter in particular for glass containers. To compensate for such manufacturing tolerances, while ensuring that all bottoms 3 of the vials can be disposed in a single plane, according to the present invention the glass containers are fixed in a positive-fit manner on a supporting structure. This positive-fit coupling is implemented in the region of the constricted neck portion 5. Particularly, the containers are supported in a positive-fit manner in the region of the constricted neck portion 5. As will be described in the following, the positive-fit members are preferably formed of a plastic material which is sufficiently flexible or elastic so that even glass containers with large manufacturing tolerances with respect to their axial length may be engaged behind or supported in a positive-fit manner in the transition region between the upper rim 6 and the constricted neck portion 5.

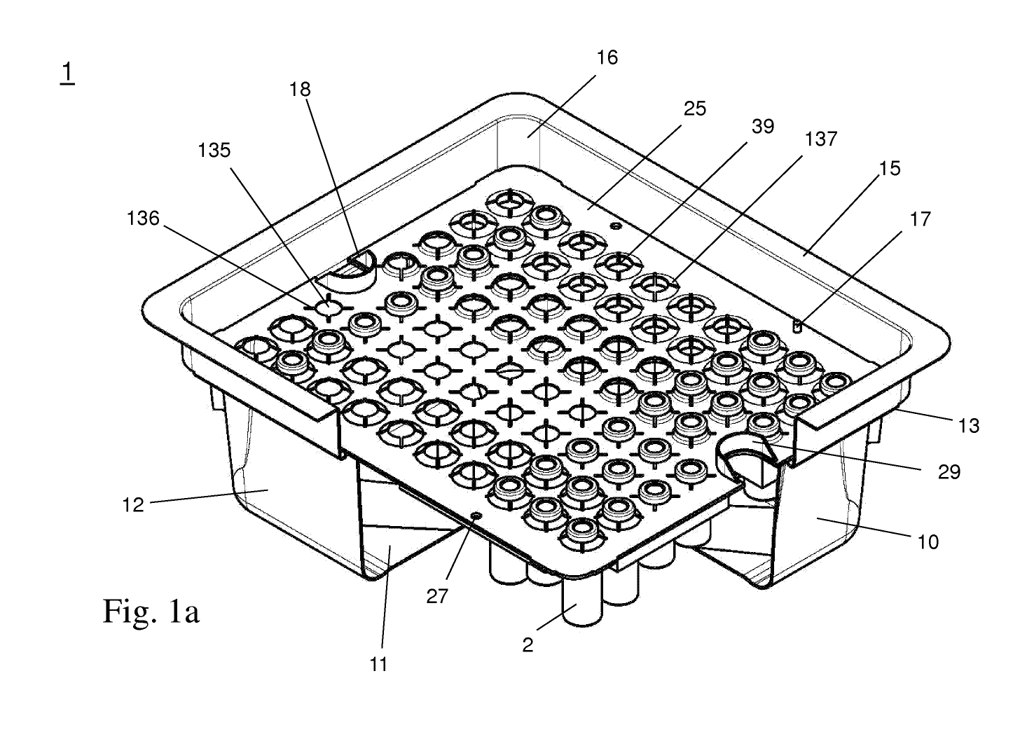

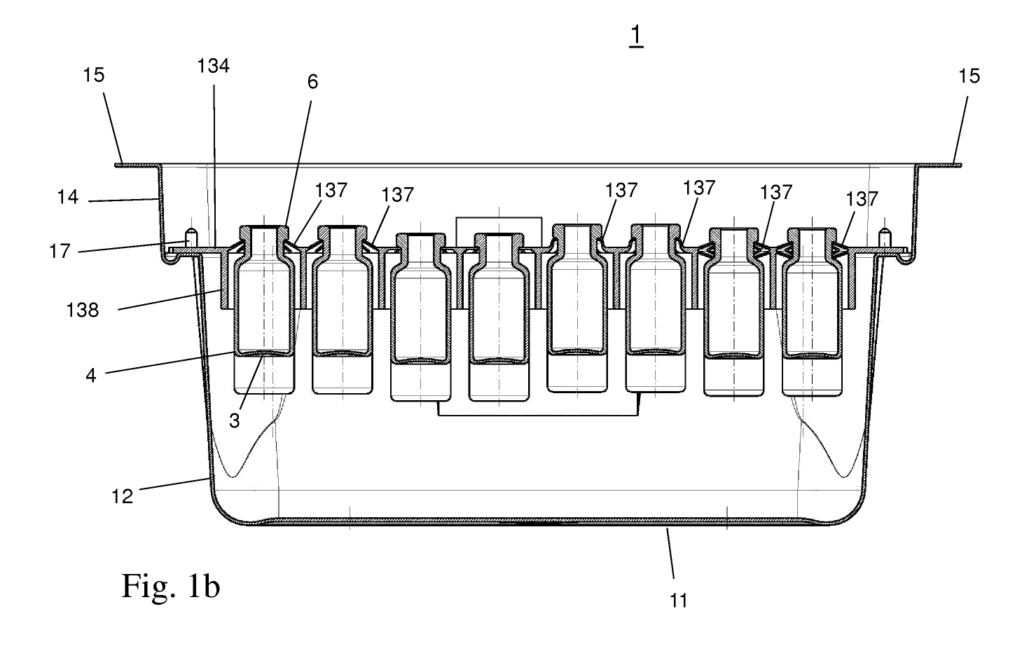

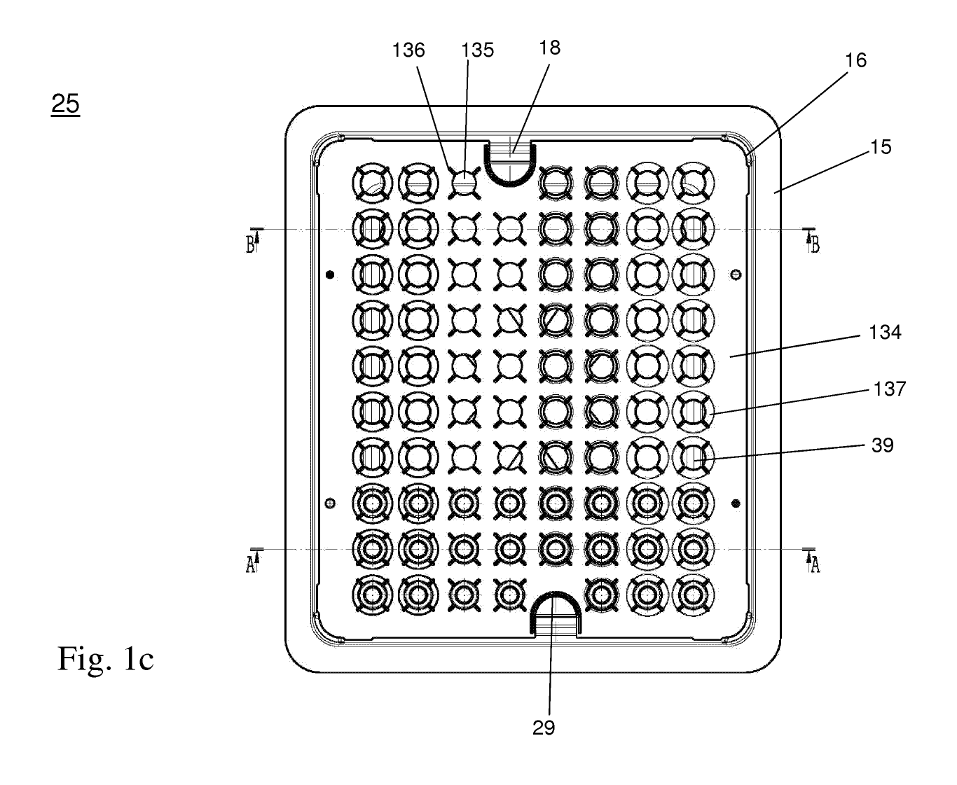

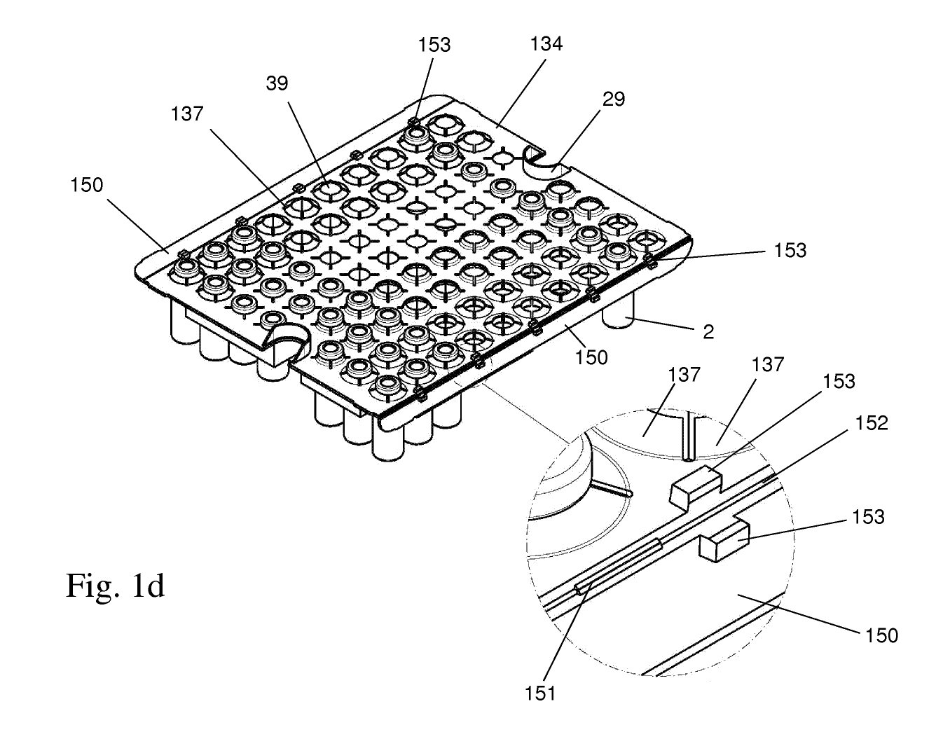

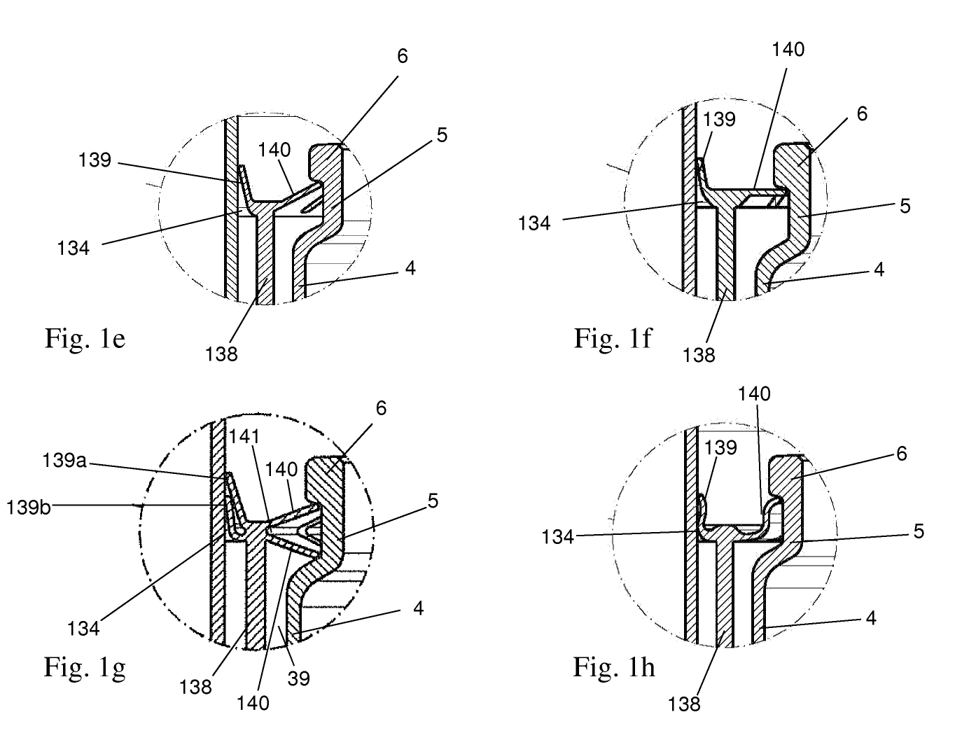

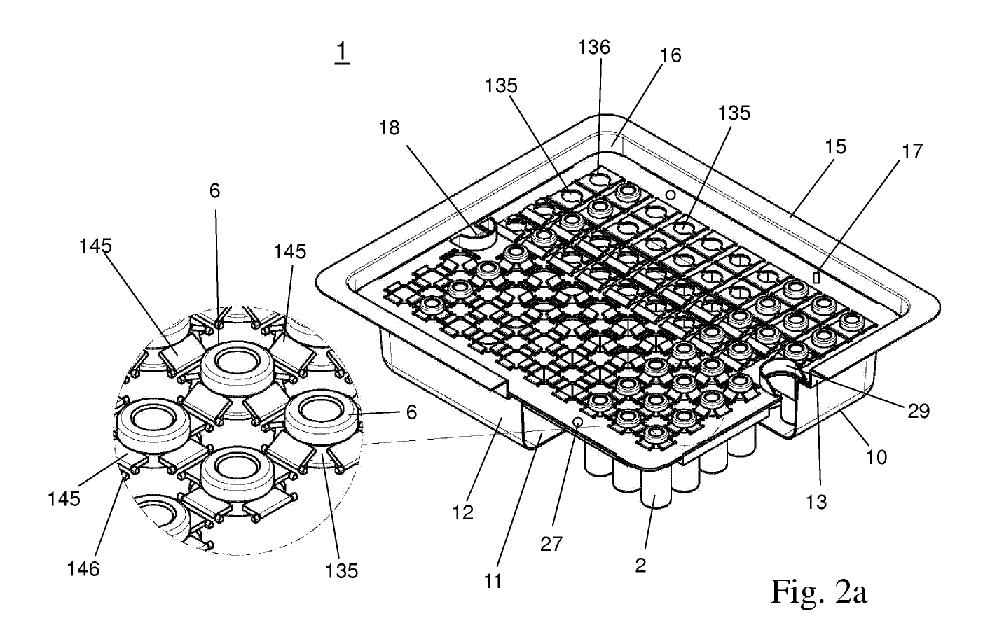

For concurrently supporting a plurality of containers, according to a first embodiment of the present invention, as shown in FIGS. 1a to 1c, a planar transport plate 25 is provided, which is formed of a plastic material, e.g. by punching-out or formed by injection-molding, and which comprises a plurality of openings 39 for accommodating the glass flasks 2 therein. These openings 39 are arranged in an array configuration, in the illustrated embodiment in a matrix configuration consisting of rows and columns extending perpendicular thereto and at equal distances to each other. Alternatively e.g. also adjacent rows of containers may be displaced relative to each other in regular intervals.

The openings are formed in ring-shaped positive-fit members 137, to be described in more detail below, and which act as flaps that are either inserted into the openings 39, particularly locked or clipped in its peripheral edge, or that are formed integrally with the planar supporting base 25, for example by means of a 1K or 2K plastic injection molding process. The spaces between the positive-fit members 137 can be formed to be entirely closed or can be formed as an opening. The containers 2 can be inserted from above or from below into the openings 39 of the positive-fit members 137. Thus, a plurality of containers 2 can be fixed in a positive-fit manner in the region of their constricted neck portions 5.

This is shown in more detail in the schematic longitudinal sections according to FIG. 1b, where it should be noted that in FIG. 1b as a summary several different variants for positive-fit members 137 are shown in a comparative representation. In the fixed state, the positive-fit members, which act as flaps, support the containers directly below the upper rim 6 and in the region of the constricted neck portion 5. As shown in FIG. 1b, the distance between the step-like transition region between the upper rim 6 and the constricted neck portion 5 and the top of the positive-fit members 137 will usually be negligible for at least the great majority of the fixed containers. Due to a certain elasticity of the positive-fit members 137, however, manufacturing tolerances of the containers in the axial direction as well as manufacturing tolerances in the radial direction can be compensated for to a certain extent and thus also containers of different diameters can be fixed in a positive-fit manner in the region of the constricted neck portion 5 of one and the same supporting structure 25.

A supporting structure 25, as shown in FIG. 1a, may be rolled-up generally just like a carpet.

For the transport and packaging of a supporting structure in the sense of the present application with the containers accommodated therein a transport and packaging container 10 (often referred to as “tub” in the prior art) is used as schematically shown in FIG. 1a. According to FIG. 1a, the container 10 is substantially box-shaped or tub-shaped and has a base 11, a circumferential side wall 12 protruding in vertical direction therefrom, a step 13 protruding substantially rectangular therefrom, a circumferential upper side wall 14 and an upper rim 15 which is formed as a flange. The corners 16 of the container 10 are suitably formed rounded. The upper side wall 14 may be formed inclined at a small angle of inclination with respect to the vertical to the base 11 in order to ease the insertion of the supporting structure 25. Such a container 10 is preferably formed from a plastics material, particularly by plastic injection molding, and is preferably formed of a clear transparent plastic in order to enable a visual inspection of the supporting structure 25 received in the container 10 and of the containers 2 supported by it.

For receiving the supporting structure 25 in the container 10, it may be surrounded by a holding frame 26 which has a supporting web which is formed closed or it may be formed continuously at least along the peripheral edge. For a reliable positioning of the supporting structure 25 in the container 10, the supporting structure 25 and the containers 10 have positioning structures that cooperate with each other, in particular in a positive-fit manner. Thus, positioning structures in the form of projections or recesses or depressions may be formed at an appropriate position, in particular on the step 13 or on the supporting surfaces 18 of the container 10, which co-operate in a positive-fit manner with corresponding recesses or depressions or projections of the supporting structure for precisely positioning the supporting structure 25 in the transport container 10. To this end, according to FIG. 1a a plurality of pin-like protrusions 17 may be formed on the step 13, which engage in corresponding centering openings. According to FIG. 1a the step 13 of the container 10 is formed as a circumferential, flat supporting surface on which the supporting frame 25 is directly supported. According to further embodiments also additional supporting surfaces 18 or supporting elements, in particular in the form of protrusions, may be formed on the side walls 12 of the container 10, as described below. In this manner, the supporting structure 25 can be positioned precisely in the container 10 and thus the plurality of containers 2 can be positioned and held in a regular array and at precisely defined positions in a transport container 10 with standardized dimensions. In particular, it can be ensured in this way that all bottoms or bottom ends of the containers 2 are positioned in a plane defined jointly and parallel to the base 11 or to the upper rim 15 of the container 10.

Although the bottom 11 of the container 10 is shown in FIG. 1a to be closed and formed integrally with the side wall 12, the lower end of the container 10 may also be formed open in the manner of the upper end, in particular with a flange-like bottom rim in the manner of the upper rim 15 so that the bottoms of the containers are freely accessible from the underside of the container 10, e.g. for processing steps in a sterile tunnel or in a freeze-dryer, as explained in detail below.

As shown in FIG. 1a, in the array configuration according to FIG. 1a, the plurality of containers 2 are supported distributed along two mutually orthogonal directions in a plane and at predetermined constant intervals. In principle, also other regular arrangements are conceivable, e.g. rows or columns of containers 2 may also be displaced relative to each other by a predetermined distance, namely in a periodic configuration having a predetermined periodicity. Thus, automated processing systems may expect the containers 2 at precisely predetermined positions upon their transfer to a processing station, which significantly reduces the efforts required for automation. As explained in more detail below, according to the present invention the containers 2 may also be processed further jointly while being within the supporting structure 25 or the container 10, especially also in a sterile tunnel or a freeze-dryer.

For enabling an easy insertion of the supporting structure 25 into the container 10 and removal from the latter, access apertures 29 are formed on two longitudinal sides of the supporting frame 26, via which gripping arms or the like may grab the supporting structure 25. As can be seen in FIG. 1a, the access apertures 29 are displaced relative to each other by a row which further facilitates an unambiguous positioning of the supporting structure 25 in the container 10.

FIG. 1b shows a schematic longitudinal section of the transport and packaging container according to FIG. 1a. FIG. 1c shows the supporting structure 25 of FIG. 1a in a plan view and in a schematic perspective view.

FIG. 1d shows a further variant of the supporting structure according to FIG. 1c, wherein rims 150 of the plate-shaped supporting base 134 may be pivoted away for further reducing the base area of the supporting base 134, for example, when this is to be transferred together with the containers to a constricted processing station, for example, a freeze-dryer having a limited base area. For this purpose, the rims 150 are coupled to the supporting base 134 via hinges 151. On the upper side of the supporting base 134 and of the rims 150 block-shaped stops 153 are provided at corresponding positions defining a coplanar alignment of the rims 150 and of the supporting base 134 in mutual abutment. According to a further embodiment (not shown), the rims 150 may also be removed from the supporting base 134. The rims 150 may, of course, be provided along all four longitudinal sides of the supporting base 134.

FIGS. 1e to 1h show further preferred variants of the positive-fit fixation of the containers. According to FIG. 1e, positive-fit members 140, which are formed like flaps and have a ring-shaped front end, are provided at the supporting base 134, which embrace the neck portion 5 in a positive-fit manner and support the upper edge 6. The flaps 140 are connected with the supporting base via the connecting portion shown (without reference numeral), the connecting portion having a smaller material thickness than the flap 140 and the supporting base, so that the flaps 140 are resiliently and pivotally supported on the supporting base. According to FIG. 1e, sealing lips 139 are provided at the lower ends of the flaps 140. When the containers are inserted from above or below into the opening formed by the flaps 140, the flaps 140 are folded back resiliently and thus provide free access to the opening in the supporting base. By means of the thickness, material and design of the connecting portion between the flap 140 and the supporting base the holding force exerted as well as the force required for inserting and removing a container can be defined easily. By means of the tongue 140 pivotally mounted on the supporting base also tolerances of containers due to different outer diameters in the region of the neck portion 5 can be compensated for easily. In principle, thus also different types of containers may be supported by the same supporting structure, for example containers with different diameters in the region of the neck portion 5.

FIG. 1f shows a further variant, according to which the flaps 140 extend substantially radially inwardly in horizontal direction when the container is held at its neck portion 5. A certain amount of radial clearance may also be provided between the front end of the flap 140 and the outer peripheral edge of the neck portion 5 of the container. During insertion of the container from above or below into the opening formed by the flaps 140, the flaps 140 are resiliently folded back in order to provide free access to the opening in the supporting base. By means of the thickness, material and design of the connecting region between the flap 140 and the supporting base the holding force exerted as well as the force required for inserting and removing a container can be defined easily.

According to FIG. 1g, the positive-fit member comprises two inclined tongues 140 extending radial inwardly, which are both pivotally supported at the supporting base, wherein the upper tongues 140 support the upper rim 6 of the container, while the lower tongues 140 abut in the transition region between the constricted neck portion 5 and the cylindrical side wall 4 of the outer wall of the container. Thickness, material and design of the connecting portion between the upper and lower tongues 140 and the supporting base can be identical or different. By means of the upper tongue 140 the holding force exerted can be adjusted to be suitable. By means of the lower tongue, the forced required during insertion and removal of the container can be adjusted to be suitable. The two tongues 140 together form a substantially V-shaped resilient holding means, which embraces around the neck portion 5 in a positive-fit manner and supports the upper rim 6. These are connected with each other via a connecting web 141 and are connected with two side sealing lips 139a and 139b via the connecting web 141. Thereby, a greater stability can be obtained in the fixation of the containers.

According to the FIG. 1h, the flap 140 is curved in an S-shaped manner and thus biased, which also enables a greater stability in the fixation of the containers. The insertion and removal of the containers may be made smooth with a suitable choice of this thickness, material and design of the connecting portion between the flap 140 and the support. In particular, the risk of snagging the vessel to the flap 140 is reduced even further here.

As can be concluded easily from FIGS. 1a to 1h, the containers can be inserted from above or from below into the openings 39 of the positive-fit members to be fixed by them in a positive-fit manner.

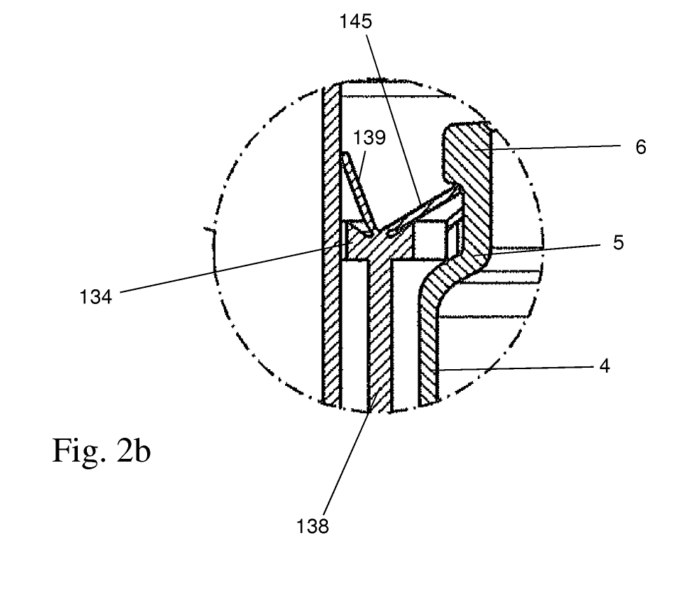

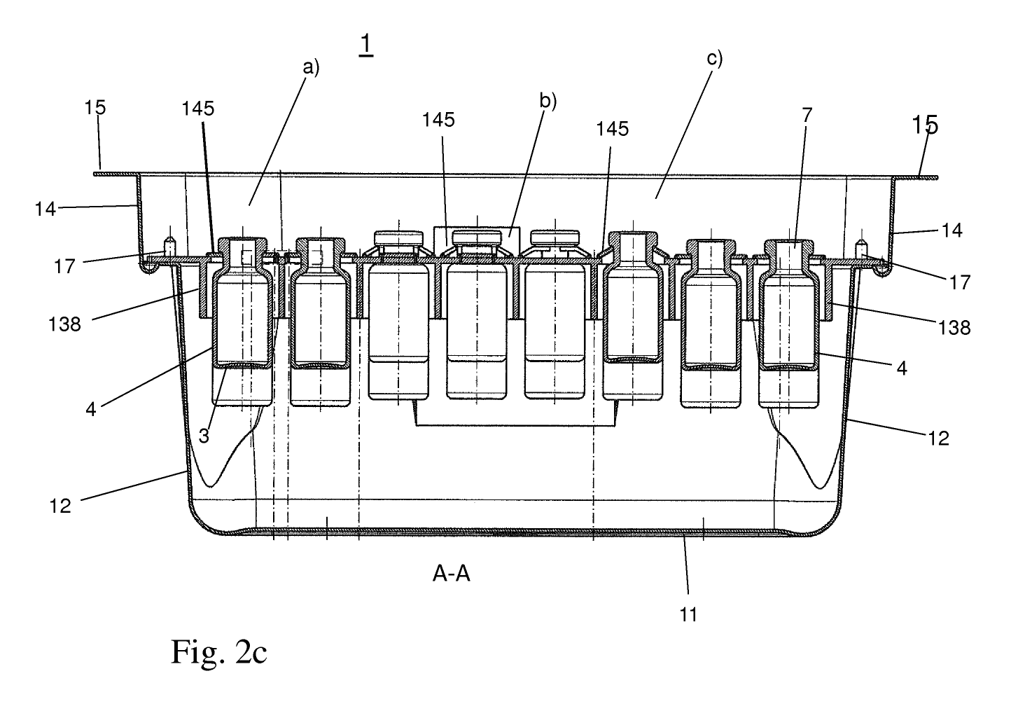

FIGS. 2a and 2b show a further embodiment, according to which the fixing of the containers is accomplished by means of pivotable supporting tongues or flaps 145, which are pivotally mounted on the supporting base 134. The supporting tongues 145 each have, at their lower end, a respective laterally projecting pin 146, which is clipped or pressed into a correspondingly designed receptacle. The supporting tongues or flaps 145 can thus be pivoted between a first position, in which the openings 135 of the supporting base 134 are exposed and the containers may be inserted freely, and a second position, in which the containers are fixed in a positive-fit manner. The force required to pivot the flaps or supporting tongues 145 can be particularly be set to be suitable by means of the supporting base of the pins 146 in the receptacles provided for this purpose.

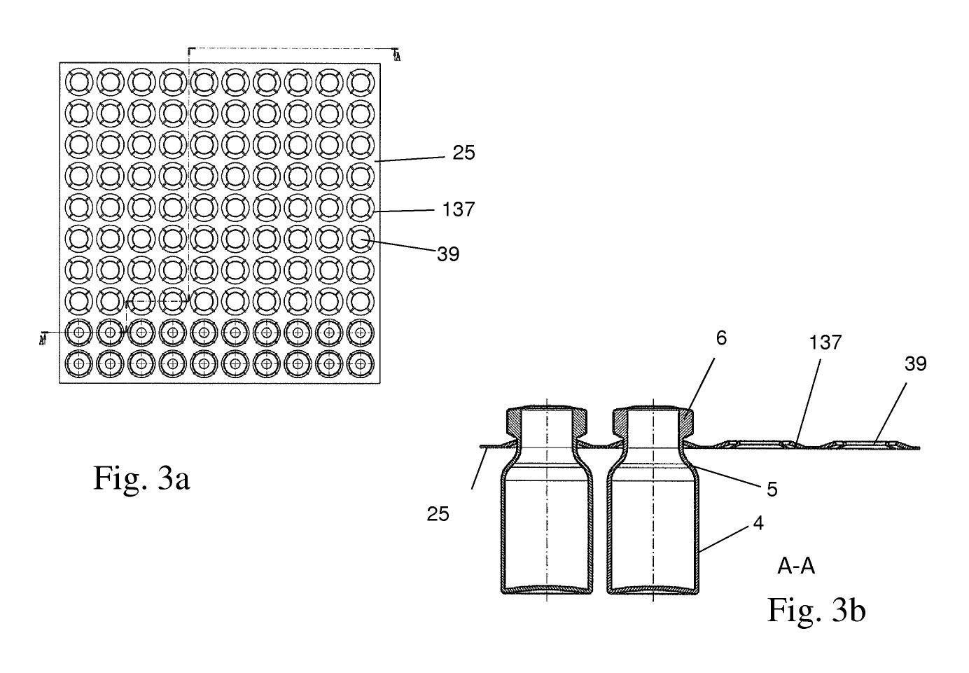

FIGS. 3a and 3b show a further variant of the supporting base according to the FIG. 1c in a schematic plan view and a longitudinal section along A-A of FIG. 3a. In this embodiment, the underside of the supporting base 25 is formed flat, while the positive-fit members 137 project from the upper side of the supporting base 25. The supporting base 25 of this embodiment may be formed integrally from a suitable plastic material using a one-component (1K) injection molding process or a two-component (2K) injection molding process.

FIGS. 4a to 4c show a further embodiment of a supporting base having a plurality of elongated receptacles 39 with a square-shaped cross section, which are formed by a plurality of transverse webs 156 disposed spaced apart from each other at regular intervals and intersecting at right angles. At the upper edge of the transverse webs 156 respective rectangular flaps 155 are provided, which are either formed integrally with the transverse webs or pivotally supported at its upper edge. Referring to FIG. 4c, a schematic longitudinal section along the line A-A of FIG. 4b, the neck portions 5 of the containers are embraced by four flaps 155 in a positive-fit manner, and the upper rims 6 of the containers are supported on them. The containers can be removed from the receptacles 39 towards above, while said flaps 155 are pivoted away.

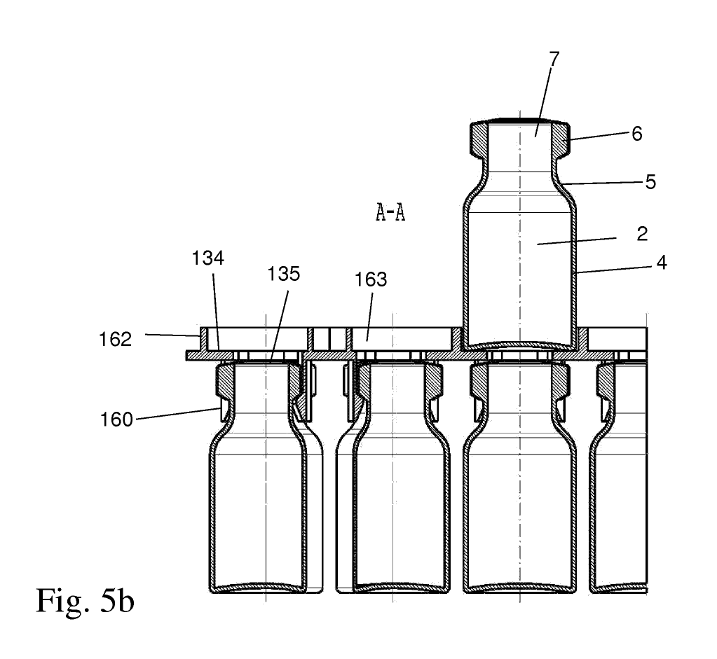

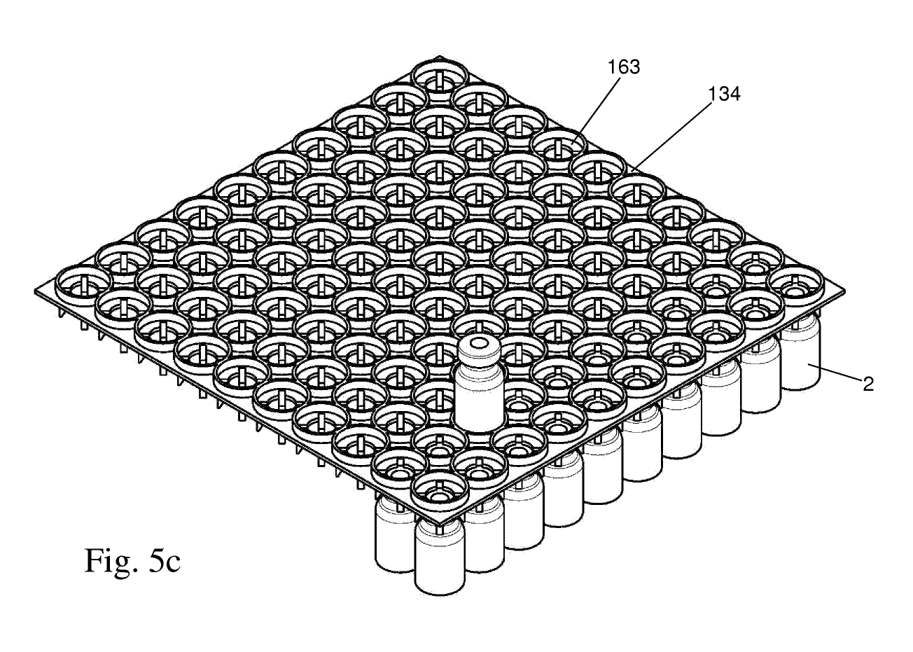

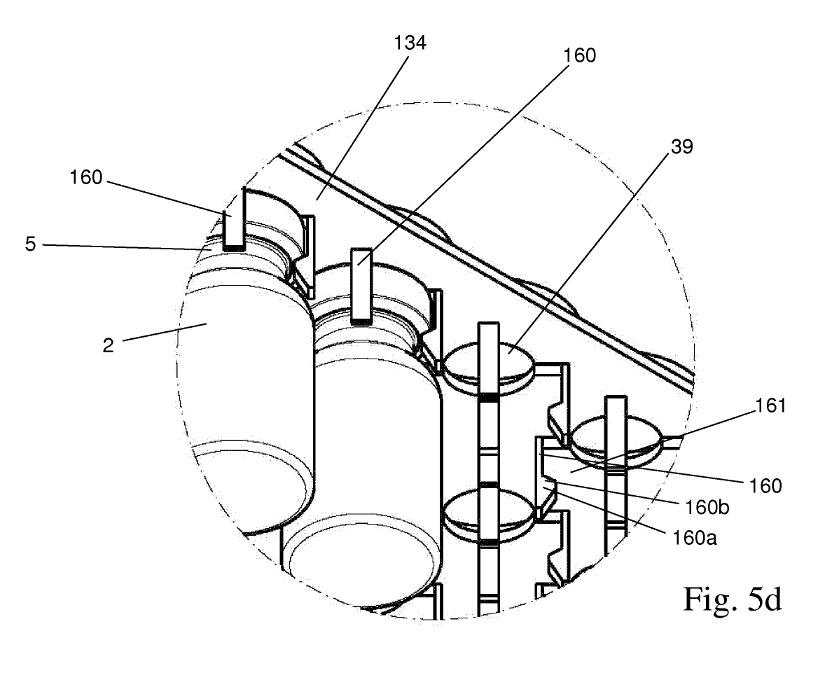

FIGS. 5a to 5d show a further embodiment of a supporting structure or a supporting base 134 (also referred to as a “nest” in the prior art). On the upper side of the supporting base 134 a plurality of annular receptacles are formed in a regular array configuration, which are formed by ring-shaped side walls 163, whose inner diameters may be matched to the outer diameter of the containers received therein. When the containers are accommodated in these receptacles, the bottoms of the containers are supported directly on the upper side of the supporting base 134, wherein the side walls 163 reliably prevent a collision of adjacent containers. The receptacles can thereby clamp the bottom ends of the containers 2.

According to the enlarged view of FIG. 5d, a greatly enlarged detail of FIG. 5c, hook-shaped latching hooks 160 protrude from the underside of the supporting base, which are disposed around the openings 135 of the supporting base 134. The containers 2 can be inserted from below the supporting base 134 into the latching hook 160, until the upper rim 6 of the containers is engaged behind by the latching hooks 160 in a positive-fit manner. In this position, the containers are reliably supported, wherein all bottoms of the containers 2 are disposed on the same height level and a collision of adjacent containers is prevented. However, the latching hooks 160 are sufficiently resilient so that the containers 2 can also be removed therefrom again under elastic deformation. As can be seen from FIGS. 5b and 5c, several layers of such supports 134 together with the containers fixed by them can be stacked one above the other.

As can be seen from FIGS. 5b and 5d, the latching hooks 160 have a lower insertion bevel 160a. Upon insertion of the containers 2 from the underside of the supporting base finally the upper rim 6 of the containers 2 gets into contact with the lower insertion bevel 160a. When the containers 2 further approach the supporting base, the upper rim 6 of the containers slides along the lower insertion bevel 160a, so that the latching hooks are resiliently pivoted radial outwardly and are thus spread apart. Finally, the lower edge of the upper rim 6 of the containers 2 (cf. FIG. 5b) slides over the narrowest part of the latching hooks 160 and subsequently the latching hooks 160 snap back to their home position in which the containers 2 can be kept clamped in the region of the neck portion 5, in particular directly below the upper rim 6. According to a further embodiment the bottom side of the upper rim 6 of the containers may also rest loosely on the downwardly inclined supporting surface 160b of the latching hooks, i.e. with a certain radial play. As can be seen in FIG. 5d, the slope of the downwardly inclined supporting surface 160b facilitates removal of the containers 2 from the supporting base. Namely, for the removal of the containers 2 towards below the bottom side of the upper rim of the containers slides along the downwardly inclined supporting surface 160b, and then over the narrowest part of the latching hook. Upon further pulling the latching hooks 160 these finally return resiliently to their home position.

While it has been stated in the previous embodiments, that the containers are placed upright and with their open ends facing towards the transport and packaging container, generally the containers may also be reversed, i.e. pointing to the bottom of the transport and packaging container with their open ends.

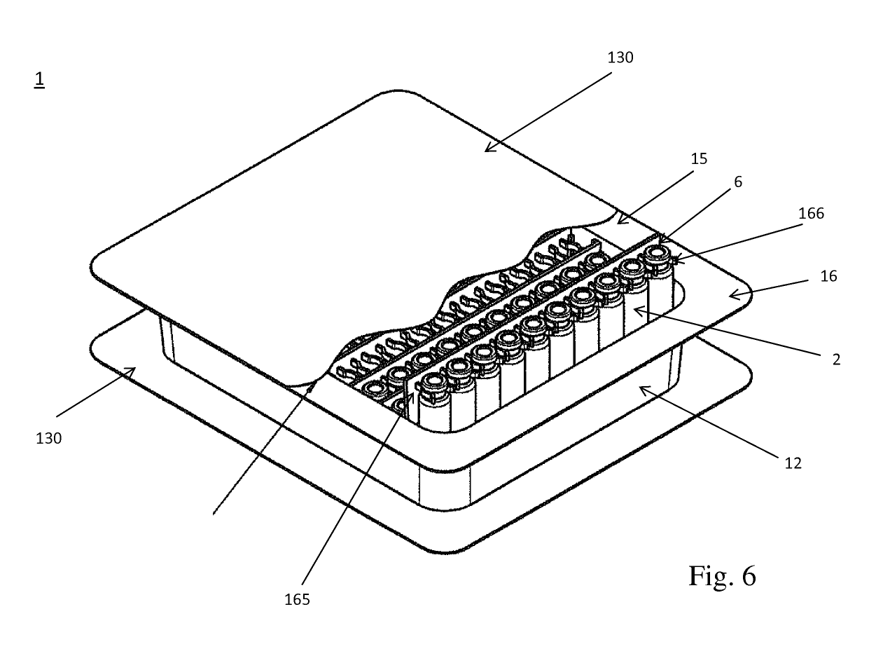

FIG. 6 shows a packaging unit, which is formed by a transport container 12, which is open at its both ends, and by a supporting structure 165 according to an embodiment not discussed in further detail, which is accommodated therein and which is closed on the upper and lower side by means of a protective foil or packaging foil 130 bonded onto the edge 15 of the transport container 12. The protective foil 130 may be in particular a gas-permeable plastic film, in particular a web of synthetic fibers such as polypropylene fibers (PP) or a Tyvek® protective film, which enables a sterilization of the containers 2 accommodated in the supporting structure 25 through the film 130. As will become apparent to a person skilled in the art easily, the transport container 12 can also be formed open only at one end, e.g. in the manner of the transport and packaging container 10 as shown schematically in FIG. 1a.

In all embodiments of the invention, antimicrobial powders may be added to the plastic of the supporting structure (of the carrier) and/or of the transport and packaging container. Antimicrobial powders, such as, for example, with Ag, Zn, Cu, Ce, Te, or I atoms or ions, are suitable for various purposes as aggregate or filler because of their biocidal, bactericidal and fungicidal effect. The biocidal effect occurs, for example against bacilli, fungi, viruses, yeasts, algae and other microorganisms. Components having a biocidal effect may be added to the plastic of the supporting structure (the carrier) and/or to the transport and packaging container in particular s glass powder, which contain the Ag₂O, CuO, Cu₂O, TeO₂, ZnO, CeO₂ and I. For use in plastics, the mechanical and optical characteristics remain largely unchanged. The powder may be added either already as nanopowders, for example, to the plastic powder mixtures during injection molding or to paints during deep-drawing processes. An antimicrobial effect can also be achieved when the plastic is provided with an antimicrobial coating containing the above-mentioned powder.

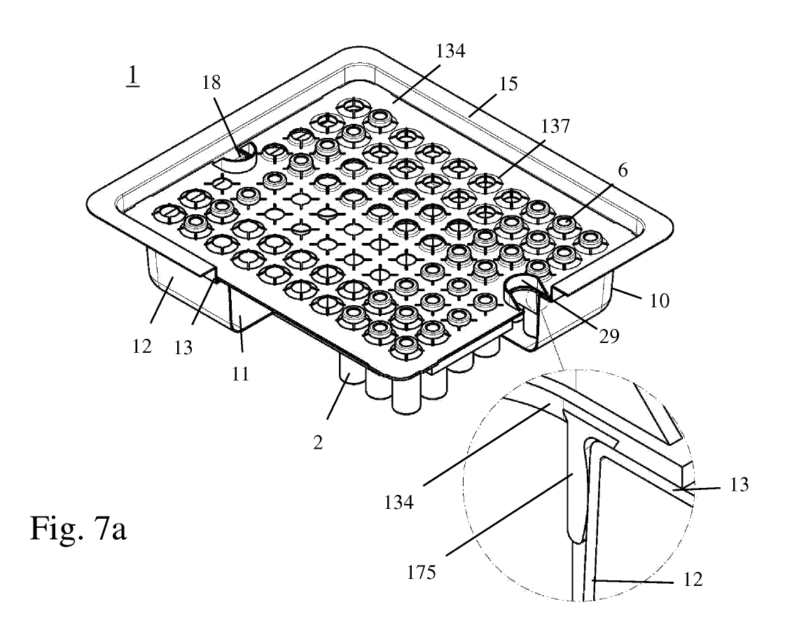

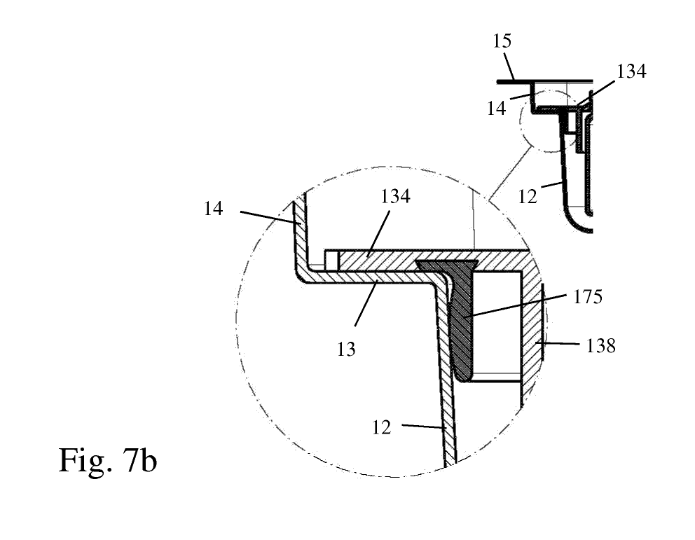

FIGS. 7a and 7b show a further embodiment of a packaging unit 1 with a holding plate 134 received in the transport and packaging container 10, which shall only serve as an exemplary description and in which a plurality of containers 2 are fixed in a positive-fit manner by means of ring elements 137. The packaging unit 1 comprises measures for identifying and/or tracking as follows: as shown in the enlarged insert of FIG. 11a, an electronic wirelessly readable RFID chip or RuBee chip 175 (a RuBee chip transmits at frequencies that can penetrate metal and water) is disposed in the region of the access aperture 29 between the supporting plate 134 and the side wall 12 and/or the step 13 of the container 10, which can be read out in a contact-less manner through the side walls of the packaging unit 1 and outputs information with regard to identity, important product characteristics (manufacturer, content, production date, expiry date, . . . ) if queried. The chip 175 may be glued into the packaging unit 1 at a suitable position, also at a different position than shown in the figure. The chip 175 may be arranged such that in the case that the packaging unit 1 is opened or that the supporting plate 134 is taken out of the packaging unit 1, the chip 175 is destroyed, for example is broken or getting inoperative. Due to lack of response from the chip 175 to a radio query an information is therefore available, which indicates that the packaging unit must have been manipulated in some way since the previous packaging process. Because the chip 175 does not respond to the radio query. This can for example be used to prove the authenticity and integrity of the packaging unit and the containers accommodated therein.

According to a further preferred embodiment the RuBee chip or RFID chip 175 is integrated in combination with other sensors that can monitor the important parameters of the transport and packaging container 1 as a function of time, the important quality or authenticity characteristics relating to containers accommodated in the transport and packaging container 1. These quality or authenticity characteristics can be recorded periodically and be stored in a memory associated with the chip or sensor. For supplying these electronic components with electric power an independent power supply may be provided in the transport and packaging container 1, in particular a battery of small dimensions or also inductively via a small wire loop. The following sensors are particularly conceived according to the present application:
a moisture sensor with or without a memory (data logging) which periodically measures the humidity prevailing in the transport and packaging container and records it, if required;
a gas sensor with or without a memory (data logging), which measures the concentration of gases in the transport and packaging container such as O₂, ozone, CO₂ or sterilization gases such as Ethylene oxide, formaldehyde, and records it, if required;
a temperature sensor with or without a memory (data logging), which periodically measures the temperature prevailing in the transport and packaging container and records it, if required;
an UV sensor with or without memory (data logging), which periodically measures UV radiation entering the transport and packaging container and records it, if required;
a gamma ray sensor, electron beam sensor or X-ray sensor with or without memory (data logging), which periodically measures radiation entering the transport and packaging container and records it, if required;

Furthermore, further measures can be taken in the transport and packaging container relating to a plagiarism protection and reliable proof of the authenticity and originality of the vials stored in the transport and packaging container. For this purpose, in particular a luminescence-based plagiarism protection may be provided, namely in the form of luminescent substances coated at a suitable place in or on the transport and packaging container that are conventionally referred to also as “phosphors”. The luminescent substances, which are preferably invisible to the human eye, can, however, be distinguished based on different spectral emission spectra in a characteristic manner. The luminescent substances are preferably composed of inorganic luminescent materials (for example, microcrystals, nanocrystals and/or quantum dots), which fluoresce and/or phosphoresce at specific wavelengths. The different types of luminescence are classified according to the duration of luminescence after the excitation in fluorescence (<1 msec) and phosphorescence (≧1 ms).

The emission wavelengths may have a narrow spectral width (for example, InBO₃:Eu or Tb) and/or also emit broadly (Ce:YAG). The spectral position depends on the composition and/or the concentration of the luminescent substances. Preparation is accomplished by mixing the luminescent substances with plastic granules, plastic powder, solvents or paints before being processed further (injection molding, deep-drawing, . . . ). Also, organic luminescent materials may be applied.

Thus it is possible to produce various packaging batches which have characteristic emission spectra, the emission lines of which depend on the concentration used and on the combination of fluorescent materials (for example, oxides, oxynitrides, nitrides, sulfides, fluorides, . . . ) and differ with regard to the wavelength and intensity ratios. The luminescent materials may for example be composed of different Eu-doped materials, such as CaS:Eu:Eu, Sr₂Si₅N₈:Eu, SrS:Eu, Ba₂Si₅N₈:Eu, Sr₂SiO₄:Eu, SrSi₂N₂O₂:Eu, SrGa₂S₄:Eu, SrAl₂O₄:Eu, Ba₂SiO₄:Eu, Sr₄Al₁₄O₂₅:Eu, SrSiAl₂O₃N:Eu, BaMgAl₁₀O₁₇:Eu, Sr₂P₂O₇:Eu, SrB₄O₇:Eu, Y₂O₃:Eu, YAG:Eu, Ce:YAG:Eu, (Y, Gd)BO₃:Eu, (Y,Gd)₂O₃:Eu. Luminescent materials may be co-doped or may be doped with other rare earth elements (scandium, yttrium, lanthanum, cerium, praseodymium, neodymium, promethium, samarium, gadolinium, terbium, dysprosium, holmium, erbium, thulium, ytterbium and lutetium) (e.g. LaPO₄:Ce, Tb, LaMgAl₁₁O₁₉:Ce, Tb, (Y, Gd, Tb, Lu)AG:Ce, Lu_{3-x-y-z}AₓAl_{5-y-z}Sc_{y}O₁₂:Mn_{z}Ca_{z}, Lu₂SiO₅:Ce, Gd₂SiO₅:Ce, Lu_{1-x-y-a-b}YₓGd_{y})₃(Al_{1-z}Ga)₅O₁₂:CeₐPr_{b}). Cheap luminescent materials for VUV excitation are LaPO₄:Pr, YPO₄:Pr, (Ca, Mg)SO₄:Pb, LuBO₃:Pr, YBO₃:Pr, Y₂SiO₅:Pr, SrSiO₃:Pb, LaPO₄:Ce, YPO₄:Ce, LaMgAl₁₁O₁₉:Ce. In the case of excitation with X-rays as an example the following luminescent materials are used: InBO₃:Tb+InBO₃:Eu, ZnSS:Ag, Y₂O₂S:Tb, Y₂SiO₅:Tb, Y₃(Al, Ga)₅O₁₂:Ce, (Zn, Cd)S:Cu, Cl+(Zn, Cd)S:Ag, Cl, Y₃(Al, Ga)₅O₁₂:Tb, Zn₂SiO₄:Mn, Zn₈BeSi₅O₁₉:Mn, CaWO₄:W, Y₂O₂S:Eu+Fe₂O₃, (Zn, Mg)F₂:Mn, Y₃Al₅O₁₂:Tb.

Purely mathematically thus several 100 billion fluorescent variants can be generated. Identification is possible with simple hand spectrometers.

An extension of the counterfeit protection can be achieved if certain emission spectra are used to excite other luminescent materials. I.e. the excitation takes place for example by means of UVCradiation (for example, wavelength=254 nm). The luminescent material emits at UVA (e.g., wavelength=450 nm), which enables other luminescent materials to be excited. Furthermore, one may obtain a time characteristic fingerprint based on the emissions, which are different in time (decay time). Also by the use of isotopes partly spectral isotope shifts can be obtained, which can be detected optically. As a result, several trillion combinations are possible. Thus, in particular, invisible fluorescent labels can be implemented in and on the transport or packaging container with excitation spectra in the X-ray spectrum (10 pm-1 nm), extreme ultraviolet (1 nm-100 nm), VUV (100 nm-200 nm), UVC (200 nm-280 nm), UVB (280 nm-320 nm), UVA (320 nm-400 nm) and/or in the blue spectral range (400 nm-480 nm). The excitation can be implemented by means of various light sources, such as X-ray tubes, lasers, LEDs, halogen lamps and/or CCFLs (cold-cathode lamps) continuously or in a pulsed manner and/or in a combination thereof. The emission spectra of the fluorescent labels may be in the UV and visible spectral range (VIS) and/or in the infrared spectral region (NIR and/or MIR). The detection can be performed with a commercially available spectrometer and or in a time-resolved manner, for example by using a boxcar amplifier to measure the time decay of the emission in a time-resolved manner by means of a detection in a time window and/or at two different times in the time interval. The time interval may be, for example, a few ns to a few ms and should be longer than the turn-off time constant of the light source. Various pigments (e.g. nanocrystals) may also be combined that fluoresce at different times, places and/or spectral positions. Furthermore, the luminescent labels can also be arranged in the form of 1D barcodes (e.g. EAN, UPC, IAN, JAN) and/or 2D bar codes (e.g. QR, DataMatrix, Maxi, point) and/or as a composite code. The barcodes can either be patterned directly on the package with e.g. a screen printing method, inkjet printing or a spraying method using a particular template or indirectly be stuck on labels (plastic or paper). Also, the application of a plurality of additive or patterned luminescent layers is possible.

The holding force respectively exerted by the positive-fit holding means on the containers is sufficient to hold the containers reliably on the supporting structure. Particularly, the holding force applied is greater than the weight of the containers, optionally including the content and sealing stopper. According to further to embodiments, the holding force be configured by manes of an appropriate design of the holding means such that it is greater than the standard forces during handling, processing or treatment of the containers in a process plant. Thereby a reliable holding of the containers is always ensured. However, according to further preferred embodiments of the invention the containers are displaced in the openings or receptacles despite the holding force, in particular displaced in axial direction or rotated. The force required for this only needs to be greater than the force exerted by the holding means.

Of course, the supporting structure (the carrier) in the sense of the present invention may also formed of a thermoplastic, thermosetting or elastomeric plastic material, wherein at least portions of the supporting structure or of the carrier are provided with a coating reducing friction to facilitate the insertion and removal of the containers.

According to a further embodiment, the supporting structure and/or transport container, or portions thereof, may be formed of fiber reinforced plastics or of a plastic to which ceramics or metals are added in order to increase its thermal conductivity. As is known, fiber reinforced plastics have a higher thermal conductivity of up to 0.9 W/(m K) if including carbon fibers. If ceramics or metals are added to the plastics, the thermal conductivity is further increased. Thus so-called heat-conductive plastics are created. Thus, a thermal conductivity of 20 W/(m K) is accomplished.

It will be readily apparent for the person skilled in the art upon reading the above description that the various aspects and features of the embodiments described above may be combined in any manner with one another, resulting in numerous further embodiments and modifications. It will be readily apparent for the person skilled in the art upon reading the above description that all such further embodiments and modifications shall be comprised by the present invention, as long as these do not depart from the general solution and scope of the present invention, as defined in the appended claims.

What is claimed is:

1. A supporting structure for concurrently holding a plurality of cylindrical containers for substances for medical, pharmaceutical or cosmetic applications, comprising
a planar rectangular supporting base having holding means, wherein
the supporting base has a plurality of openings, which are disposed in a regular array configuration, and has an upper side and a bottom side opposite to said upper side, and
said holding means are associated with said openings, wherein
said holding means are configured for supporting said plurality of containers at said supporting base in a positive-fit manner, in which supporting structure
said holding means protrude from said bottom side of said supporting base,
said holding means are configured for supporting said containers at their upper rim in a positive-fit manner, and
receptacles are provided on said upper side of said supporting base, wherein
said receptacles are configured for accommodating containers at the upper side of said supporting base.

2. The supporting structure of claim 1, wherein the receptacles are configured such that bottoms of the containers are supported directly on the upper side of the supporting base.

3. The supporting structure of claim 1, wherein the receptacles are formed by circumferential side walls, wherein an inner diameter of the receptacles thus formed is matched to the outer diameter of the containers to be accommodated therein.

4. The supporting structure of claim 1, wherein the holding means are formed as resilient latching hooks, wherein said latching hooks project from the bottom side of the supporting base and are disposed distributed around the openings of the supporting base.

5. The supporting structure of claim 4, wherein the latching hooks are configured to engage behind the upper rim of the containers in a positive-fit manner in order to fix the containers.

6. The supporting structure of claim 4, wherein the latching hooks have a bottom insertion bevel.

7. The supporting structure of claim 6, wherein the latching hooks further comprise a bevel, said bevel facing the respective opening of the supporting base, wherein said upper rim of a container supported by the latching hooks rests on said bevel.

8. The supporting structure of claim 4, wherein the latching hooks are formed integrally with the supporting base.

9. The supporting structure of claim 1, wherein webs are provided between the openings of the supporting base, said webs being configured to prevent a direct contact between adjacent containers that are supported by the supporting structure.

10. The supporting structure of claim 1, wherein the supporting base comprises rim portions, wherein said rim portions can be removed or pivoted away so that the base area of the supporting structure can be reduced as a whole by removing or pivoting away the rim portions.

11. The supporting structure of claim 1, wherein the holding means are configured such that at least a major part of the bottoms or bottom ends of the containers is freely accessible from the bottom side of the supporting base, and that the containers are supported on said supporting base such that all bottoms or bottom ends of the containers are arranged at the same distance from the upper side of the supporting base or may be arranged in this manner for jointly spanning a plane.

12. The supporting structure of claim 1, wherein the supporting structure is formed of an antimicrobial plastic material, wherein
the plastic material is selected from a group consisting of a thermoplastic, a thermosetting plastic or an elastomeric plastic material, wherein
an antimicrobial powder or glass powder is added to said plastic material, and
the antimicrobial powder or glass powder is added to the plastic material solely or principally in those parts of the plastic material that are close to the surface.

13. A transport or packaging container for a plurality of containers for substances for medical or pharmaceutical applications, comprising
a container which is box-shaped, and
a supporting structure for concurrently supporting the plurality of containers, wherein
the supporting structure is accommodated in the box-shaped container,
in which supporting structure
said supporting base has a plurality of openings, which are disposed in a regular array configuration, and
said supporting base has an upper side and a bottom side opposite to said upper side, and
said holding means are configured for supporting said plurality of containers at said supporting base in a positive-fit manner, wherein
said holding means protrude from said bottom side of said supporting base,
said holding means are configured for supporting said containers at their upper rim in a positive-fit manner, and
receptacles are provided on said upper side of said supporting base, wherein
said receptacles are configured for accommodating containers at the upper side of said supporting base.

14. The transport or packaging container of claim 14, further comprising
a protective or packaging foil which is bonded to an upper edge of the box-shaped container and
an identification or tracking means for identifying or tracking the transport or packaging container or the supporting structure with the containers held by the latter, wherein
the identification or tracking means is coupled to the supporting structure and/or the transport or packaging container and/or the protective or packaging foil such that the identification or tracking means is destroyed if the transport and packaging container is opened or if the supporting structure or the containers accommodated therein are removed or handled.

15. The transport or packaging container of claim 14, wherein the identification or tracking means is an RFID-chip or a RuBee-chip for reading out information in a contactless manner, wherein
said transport or packaging container further comprises at least one sensor to monitor time-dependent parameters of the transport or packaging container or to monitor and record such parameters as a function of time.

16. A supporting structure for concurrently supporting a plurality of cylindrical containers for substances for medical, pharmaceutical or cosmetic applications, comprising
a planar rectangular supporting base having holding means, wherein
the supporting base has a plurality of openings or receptacles, which are disposed in a regular array configuration, and has an upper side and a bottom side opposite to said upper side, and
said holding means are configured for supporting said plurality of containers at said supporting base in a positive-fit manner, in which supporting structure
said holding means are formed as flaps,
said flaps are arranged distributed around the openings or receptacles of the supporting base, wherein
said flaps associated with a respective opening or receptacle
are pivoted away in a first position in which the opening or receptacle is completely released and
are flapped back towards the opening or receptacle in a second position in order to jointly support an upper rim of the container accommodated in the respective opening or receptacle.

17. The supporting structure of claim 16, wherein the flaps are formed integrally with the supporting base.

18. The supporting structure of claim 17, wherein the flaps are connected with the supporting base via a connecting portion, wherein
a material thickness of the connecting portion is smaller than that of the supporting base and/or of the flaps so that the flaps are pivotally and resiliently mounted on the supporting base.

19. The supporting structure of claim 16, wherein the flaps are positively connected to the supporting base.

20. The supporting structure of claim 19, wherein the flaps comprise pins projecting sideward, wherein the pins are clipped into corresponding receptacles which are formed on the supporting base.

21. The supporting structure of claim 16, wherein the front ends of the flaps have a recess shaped as a segment of a circle, whose radius of curvature is matched to the outer radius of the containers to be supported.

22. The supporting structure of claim 16, wherein the flaps are rectangular.

23. The supporting structure of claim 16, wherein the flaps are provided at the upper rim of the associated receptacles, wherein
the receptacles have a rectangular or square-shaped cross-section, the opening width of which is matched to the outer diameter of the containers to be supported.
